(19) United States
(12) Patent Application Publication
(10) Pub. No.: US 2007/0123418 A1
(43) Pub. Date: May 31, 2007

(54) Catalyst composition containing gallium for purifying exhaust gases of internal combustion engine

(76) Inventors: Hyun-Sik Han, Ansan-city (KR); Jin-Woo Song, Shiheung-city (KR); Jae-Au Ha, Shiheung-city (KR)

Correspondence Address: NEEDLE & ROSENBERG, P.C., SUITE 1000, 999 PEACHTREE STREET, ATLANTA, GA, 30309-3915, US

(21) Appl. No.: 11/604,430

(22) Filed: Nov. 27, 2006

(30) Foreign Application Priority Data
Nov. 28, 2005 (KR) 2005/0114021
Apr. 21, 2006 (KR) 2006/0036019

(51) Int. Cl. B01J 23/42

(52) U.S. Cl. 502/339

(57) ABSTRACT

The invention relates to a catalyst composition for purifying exhaust gases of an internal combustion engine including a support impregnated with a first platinum group metal component and a metal component including gallium, which is a catalyst of a type commonly called a “Three-Way Conversion (TWC)” catalyst, and which improves the reduction of NOx and the oxidation of HC and CO.

### BACKGROUND OF THE INVENTION

1. Field of the Invention

The present invention relates to a catalyst composition for purifying the exhaust gases of an internal combustion engine and, particularly, to a catalyst composition containing a gallium for purifying the exhaust gases of an internal combustion engine, which is a catalyst of a type commonly called a “Three-Way Conversion (TWC)” catalyst, and which improves the reduction of nitrogen oxides (NOx) and the oxidation of hydrocarbons (HC) and carbon monoxide (CO). More particularly, the present invention relates to a catalyst composition which does not contain expensive platinum (Pt).

2. Description of the Related Art

Generally, Three-Way Conversion (TWC) catalysts are useful in a number of fields including the purification of pollutants such as nitrogen oxides (NOx), hydrocarbons (HC) and carbon monoxide (CO), which are discharged from internal combustion engines such as gasoline fuel engines for automobiles and other purposes. The TWC catalyst is multi-functional in that it can simultaneously catalyze the oxidation of HC and CO and the reduction of NOx.

Emission standards for NOx, CO and unburned HC pollutants have been set by various countries and must be met by new vehicles. In order to meet such standards, catalytic converters containing a TWC catalyst are located in the exhaust gas line of internal combustion engines. Such catalysts promote the oxidation of unburned HC and CO by oxygen as well as the reduction of NOx. For example, techniques for purifying automobile exhaust gases, which store oxygen to facilitate the reduction of NOx somewhat during lean operation, and discharge the stored oxygen to promote the oxidation of HC and CO during rich operation, thereby treating exhaust gases of engines, are commonly known.

TWC catalysts having good catalytic activity and long life include one or more platinum group metals such as platinum (Pt), palladium (Pd), rhodium (Rh) and ruthenium (Ru). These TWC catalysts are used with a high surface area refractory oxide support, such as a high surface area alumina coating material, etc. The support is carried on a suitable carrier or substrate, such as a monolithic carrier comprising a refractory ceramic or metal honeycomb structure, or refractory particles such as spheres or short, extruded segments of a suitable refractory material. Generally, these TWC catalysts are used with oxygen storage components, including alkaline earth metal oxides such as calcium oxides (CaO), strontium oxides (SrO) and barium oxides (BaO), alkali metal oxides such as potassium oxides (K₂O), sodium oxides (Na₂O), lithium oxides (Li₂O) and cesium oxides (Cs₂O), and rare earth metal oxides such as cerium oxides, lanthanum oxides, praseodymium oxides and neodymium oxides.

The high surface area alumina support materials, also commonly called “gamma alumina” or “activated alumina”, typically have a BET surface area of 60 m²/g or more. Such activated alumina is usually a mixture of the gamma and delta phases of alumina, but may also contain substantial amounts of eta, kappa and theta alumina phases. The use of refractory metal oxides other than activated alumina as a support for at least some of the catalytic components in a given catalyst has been disclosed.

Recently, as the regulations for automobile exhaust gases become stricter, the manufacturing cost rises due to the increase in the content of platinum included in the TWC catalyst, therefore attempts to replace all or some of the platinum with palladium have been continuously made to overcome this problem. Meanwhile, as shown in FIG. 1, the HC oxidation rate obtained by the Pt—Rh based catalyst is better than that obtained by the Pd—Rh based catalyst, therefore various researches to physically and/or chemically improve the Pd—Rh based catalyst has been conducted.

U.S. Pat. No. 4,294,726 discloses a TWC catalyst composition containing platinum and rhodium, which is obtained by impregnating a gamma alumina carrier material with an aqueous solution containing cerium, zirconium and iron salts, or mixing the carrier material with the respective oxides of cerium, zirconium and iron, tempering the carrier material in air at a temperature of 500° C.˜700° C., and then impregnating the carrier with an aqueous solution of a salt of platinum and a salt of rhodium, drying and subsequently treating with flowing gas containing hydrogen at a temperature of 250° C.˜650° C.

Japanese Unexamined Patent Publication No. 1985-19036 discloses a catalyst for purifying exhaust gases, which has improved carbon monoxide removal performance. The catalyst includes a cordierite substrate and two alumina layers laminated on the surface of the substrate. The lower alumina layer includes platinum or vanadium deposited thereon, and the upper alumina layer includes rhodium and platinum or rhodium and palladium.

Japanese Unexamined Patent Publication No. 63-205141 discloses a catalyst for purifying exhaust gas, which includes the lowermost layer including platinum or platinum and rhodium dispersed on an alumina carrier containing rare earth oxides and the uppermost coating layer including palladium and rhodium dispersed on a carrier containing alumina, zirconia and rare earth oxides.

Meanwhile, U.S. Pat. No. 4,587,231 discloses a method of producing a three-way catalyst for purifying exhaust gases.

The present applicant filed a patent application for a catalyst composition containing iridium for purifying exhaust gases of an internal combustion engine. This patent application disclosed a catalyst composition for purifying exhaust gases which can improve low temperature activity and high temperature activity by adding more iridium than the amount of impurities that are present.

Although catalyst compositions for purifying exhaust gases of an internal combustion engine can be found in many other patent documents, a catalyst composition for purifying exhaust gases of an internal combustion engine which improves the reduction of NOx using a palladium-rhodium and a gallium, rather than an expensive platinum, has not been disclosed anywhere.

### SUMMARY OF THE INVENTION

While the present inventor has researched the effects of a gallium contained in a palladium-rhodium based catalyst on the oxidation rate of HC and the conversion rate of NOx, the present inventor has found that a catalyst composition containing a gallium for purifying exhaust gases of an internal combustion engine has excellent effects in the denitrification of exhaust gases and the oxidation of HC and CO. As the result of the findings, the present invention has been completed.

The present inventor has selected gallium as a material which exhibits a high thermal stability, and has an excellent dehydrogenation efficiency for saturated hydrocarbons, such as propane or butane, and an excellent oxidation power for unsaturated hydrocarbons, and has mixed the gallium with a palladium catalyst component, thereby completing the present invention, which can improve a deNOx effect.

Accordingly, the present invention provides a catalyst composition for purifying exhaust gases of an internal combustion engine, which is a catalyst of a type commonly called a “Three-Way Conversion (TWC)” catalyst, including a support impregnated with a precious metal component including palladium and a metal component including gallium, which improves the effect of reducing NOx.

The TWC catalyst is multi-functional in that it can substantially concurrently realize the oxidation of HC and CO and the reduction of NOx, and a catalyst composition containing a gallium according to the present invention can greatly improve the effect of reducing NOx, compared to a conventional catalyst composition. The reason that the effect of reducing NOx is improved is because hydrogen gas (H2), generated by the dehydrogenation of saturated hydrocarbons using a gallium, is used effectively in the reduction of NOx. Further, it has been found that the catalyst composition containing a gallium can also be effectively used in the oxidation of HC and CO.

### BRIEF DESCRIPTION OF THE DRAWINGS

The above and other objects, features and advantages of the present invention will be more clearly understood from the following detailed description, taken in conjunction with the accompanying drawings, in which:

FIG. 1A and 1B are graphs showing HC conversion rates obtained using a platinum-rhodium based catalyst and a palladium-rhodium based catalyst, respectively;

FIG. 2 is a graph showing the degree of dehydrogenation reaction measured using fresh catalysts;

FIG. 3; is a graph showing the degree of dehydrogenation reaction measured using aged catalysts;

FIG. 4 is a graph showing real measurement results (accumulated emissions of NOx) using the catalyst of the present invention and the catalysts of comparative examples;

FIG. 5 is a graph showing real measurement results (concentrations of NOx discharged from a vehicle at phase 1) using the catalyst of the present invention and the catalysts of comparative examples;

FIG. 6 is a graph showing real measurement results (concentrations of NOx discharged from a vehicle at phase 3) using the catalyst of the present invention and the catalysts of comparative examples; and

FIG. 7 is a graph showing measurement results (concentrations of NOx discharged from an engine) using the catalyst of the present invention and the catalysts of comparative examples.

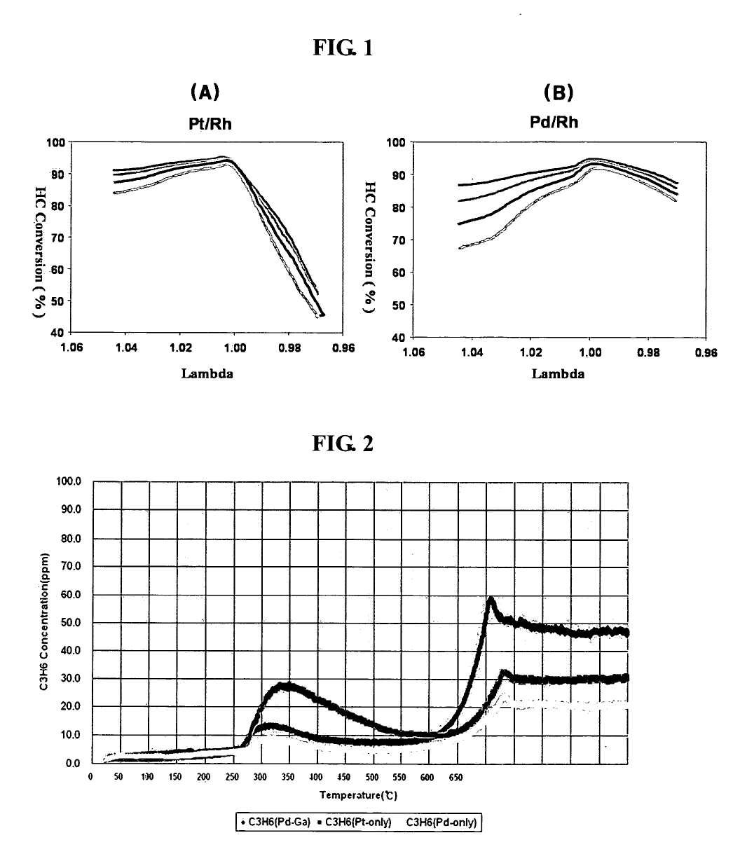

### DESCRIPTION OF THE PREFERRED EMBODIMENTS

The present invention will be described in detail with reference to the accompanying drawings below.

In the preferred example of the present invention, a catalyst composition includes a support, any one of a platinum group metal component other than platinum, preferably a precious metal component including palladium, and a metal component including gallium, both of which are carried on the support. Further, as commonly known, the catalyst composition may include an oxygen storage component selected from the group consisting of alkaline earth metal components, alkali metal components and rare earth metal components.

In the selective example of the invention, there is provided a catalyst composite including a first layer and a second layer. The first layer of the catalyst composite includes a first support, a first platinum component, and any oxygen storage component selected from the group consisting of alkaline earth metals, alkali metals, and rare earth metals. The first layer may additionally include a first zirconium component. The second layer of the catalyst composite includes a second support, a second platinum group metal component other than platinum, preferably a precious metal component including palladium, and a metal component including gallium. Further, as commonly known, the second layer may additionally include a second zirconium component.

As described above, in particular, the catalyst composition containing a gallium according to the invention can effectively reduce NOx. The first support and the second support may be identical or different compounds, and may be selected from the group consisting of a silica compound, an alumina compound and a titania compound. Preferably, the first support and the second support are activated compounds selected from the group consisting of alumina, silica, silica-alumina, aluminosilicate, alumina-zirconia, alumina-chromia and alumina-ceria. More preferably, the first support and the second support are activated aluminas. The compositions of the first layer and the second layer may additionally include nickel, manganese and iron used for removing sulfides, for example hydrogen sulfides, but these are commonly known.

When a monolithic carrier substrate is thinly coated with the catalyst composition, the ratios of components are designated by grams of the components per liter of the catalyst and substrate (g/l). These values include cell sizes constituting gas flow paths of the several monolithic carrier substrates. The terms ‘catalyst metal components’ and ‘metal including the component’, used in this specification, refer to a catalytically effective metal form regardless of whether or not the metals exist in the form of elements, alloys, or compounds such as oxides. The following Examples according the invention were performed to measure the exhaust gas purification effects of palladium and gallium to the exclusion of the rhodium necessary for purifying exhaust gases. In the following examples of the invention, although the rhodium was excluded for the sake of simplicity of the experiments, it will be apparent from other documents that the rhodium is included in the palladium. Although the examples are described without inclusion of rhodium for the sake of simplicity of comparative experiments, but it will be apparent to those skilled in the art that the rhodium is not excluded from the scope as defined by the claims.

### EXAMPLE 1

An activated alumina impregnated with Pd and Ga was prepared by impregnating 1.58 g/l of palladium nitrate and 1.0˜1.58 g/l of gallium nitrate into 84.0 g/l of gamma-alumina powder, and slurry was prepared by dispersing 5.0 g/l of CeO₂-ZrO₂ composite ceria powder in water and was then milled until a predetermined particle size distribution was attained. A ceramic honeycomb structure, having a CPSI of 600 cells/inch² and a wall thickness of 4.0 milliinches, was coated with the slurry. The coating process was performed by dipping a substrate (105.7 * 115) into the slurry, draining the slurry, and then removing the excess slurry through compressed air injection. The coated honeycomb structure was dried at a temperature of 120° C. for 4 hours, and was baked at a temperature of 550° C. for 2 hours, thereby fabricating a catalyst.

### EXAMPLE 2

The catalyst fabricating process was performed as in Example 1, except that 2.58 g/l of gallium nitrate was applied, thereby fabricating a catalyst for measuring the oxidation of HC and CO.

### EXAMPLE 3

The catalyst fabricating process was performed as in Example 1, except that 5.00 g/l of gallium nitrate was applied, thereby fabricating a catalyst for measuring the oxidation of HC and CO.

### COMPARATIVE EXAMPLE 1

Activated alumina impregnated with only Pd was prepared by impregnating 1.58 g/l of palladium into 84.0 g/l of gamma-alumina powder, and slurry was prepared by dispersing 5.0 g/l of CeO₂-ZrO₂ composite ceria powder in water and was then milled until a predetermined particle size distribution was attained. Subsequently, the slurry was processed as in Example 1, thereby fabricating a comparative catalyst 1.

### COMPARATIVE EXAMPLE 2

Activated alumina impregnated with only Pd was prepared by impregnating 1.78 g/l of platinum chloride into 84.0 g/l of gamma-alumina powder, and slurry was prepared by dispersing 5.0 g/l of CeO₂-ZrO₂ composite ceria powder in water and was then milled until a predetermined particle size distribution was attained. Subsequently, the slurry was processed as in Example 1, thereby fabricating a comparative catalyst 2.

Test Method

Fresh catalysts were aged in a furnace at a temperature of 1050° C. for 5 hours, and then the degree of dehydrogenation was tested, while introducing a feed gas including 1000 ppm of propane, 6.75% of CO₂, 2% of H₂O and nitrogen balance at a rate of 400 ml/min into the furnace and varying the temperature (room temperature ˜650° C.). Meanwhile, the NOx conversion rate was observed through real car tests.

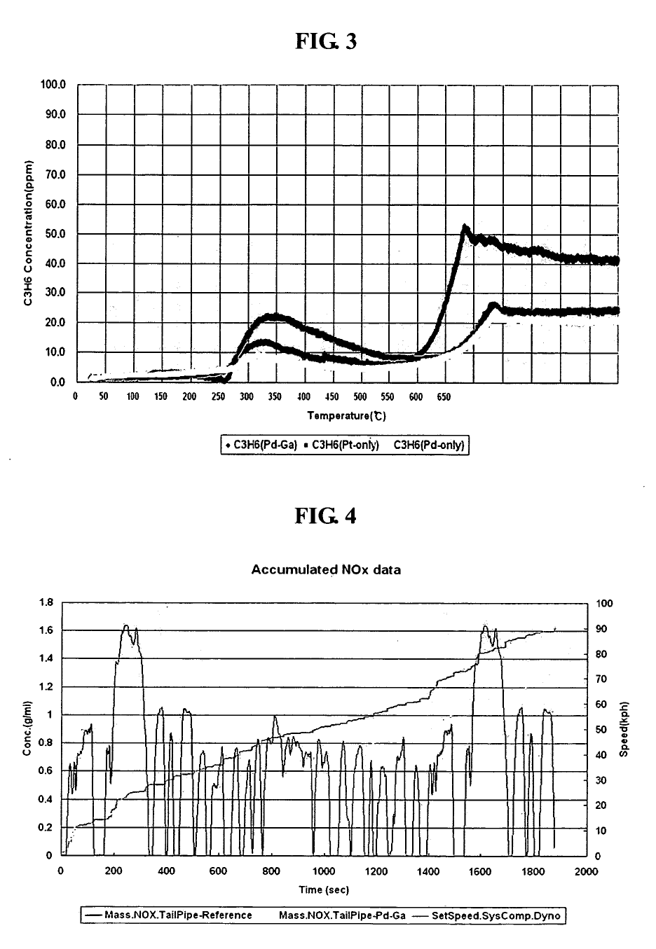

FIG. 2 is a graph showing the degree of dehydrogenation of the introduced propane gas using fresh catalysts. The dehydrogenation is primarily performed at a temperature of 270° C., is maximum at a temperature of about 330° C., and is secondarily performed at a temperature of 600° C. Although this phenomenon is common in the catalysts of example 1 and Comparative Examples 1 and 2, dehydrogenation using a Pt—Al₂O₃ catalyst (Comparative Example 2) is superior to dehydrogenation using a Pd—Al₂O₃ catalyst (Comparative Example 1). Meanwhile, the Pd—Ga—Al₂O₃ catalyst of example 1 is superior to the Pd—Al₂O₃ catalyst in the dehydrogenation, and the measurement results of the dehydrogenation were believed to fulfill the object of improving the reduction of NOx using hydrogen gas (H₂) generated through the dehydrogenation reaction while entirely or partially replacing Pt with Pd. This inclination is the same as in FIG. 3, showing the propane conversion rate using aged catalysts.

FIG. 4 is a graph showing the amount of NOx accumulated through real car tests using a Pd—Ga—Al₂O₃ catalyst (Example 1) and a Pd—Al₂O₃ catalyst (Comparative Example 1), and it has been found that the Pd—Ga—Al₂O₃ catalyst consistently decreased the discharge of NOx in the measurement sections. In Example 1, although comparative tests were performed by impregnating 1.58 g/l of gallium nitrate, it will be obvious to those skilled in the art that a co-catalyst, particularly a deNox catalyst, may be added in a range of approximately 0.2˜20 g/l.

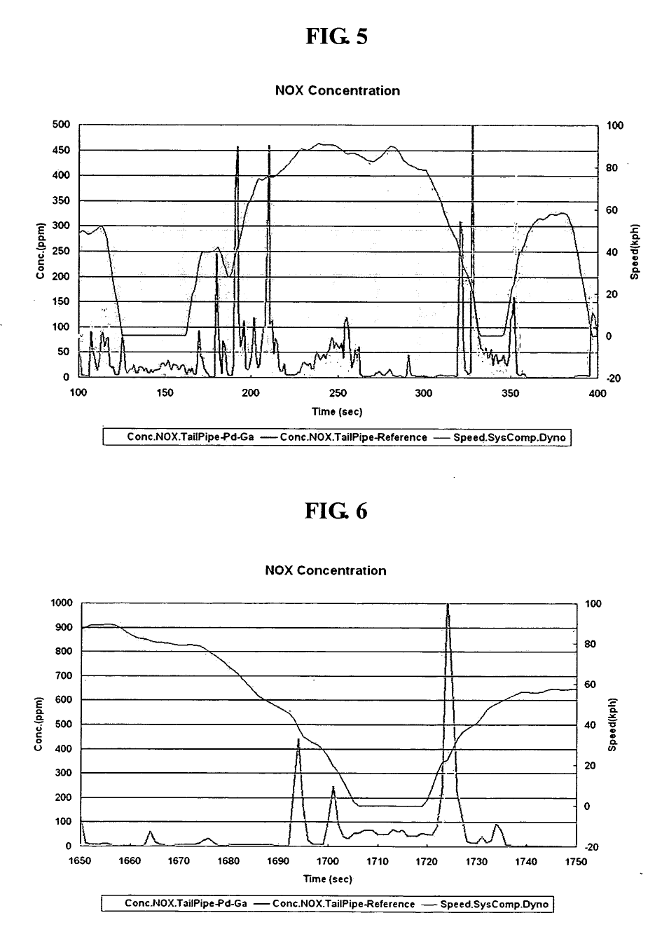

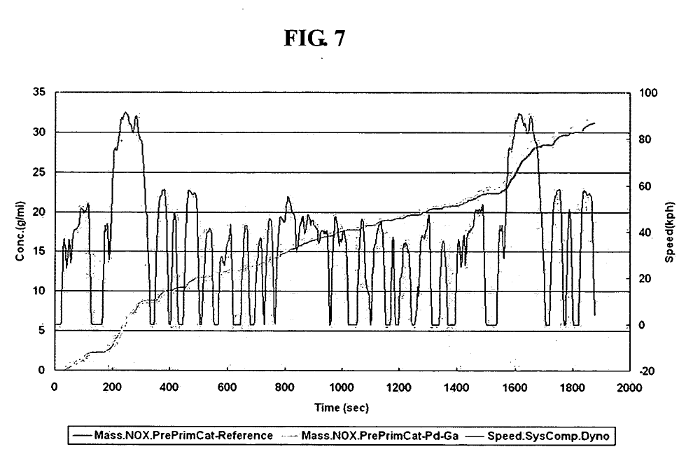

FIGS. 5 and 6 are graphs showing concentrations of NOx discharged from vehicles at phase 1 and phase 3 in real car tests, and it has been found that a high concentration of NOx was discharged using a Pd—Al₂O₃ catalyst, compared to a Pd—Ga—Al₂O₃ catalyst. In order to ascertain whether the difference in the concentration of NOx discharged from vehicles is derived from the purifying ability of the catalysts at phase 1 and phase 3, the measurement results of the concentrations of NOx discharged from an engine before the NOx passes through the catalysts are shown in FIG. 7. In this case, the concentrations of NOx discharged from an engine showed the same results as both of the catalysts (Example 1 and Comparative Example 1), thus it has been found that the effects of reducing NOx exhaust in FIGS. 4 to 6 are due to the change of the catalyst components according to the invention.

The following Tables show the results of real car tests for finding the oxidation of HC and CO using the catalysts in Examples 1 to 3 and Comparative Example 1 (test vehicles: XD 2.0 A/T and M/T, catalyst attachment position: Manifold Catalytic Converter (MCC), test mode: FTP-75).

TABLE 1
Total emissions (mg/mile) of HC and
CO at FTP-75 (XD 2.0 A/T) mode

| | HC | CO/10 |
|---|---|---|
| Comparative Example 1 | 33.2 | 66.4 |
| Example 1 | 29.6 | 64.0 |
| Example 2 | 28.9 | 61.3 |
| Example 3 | 28.4 | 47.9 |

TABLE 2
Total emissions (mg/mile) of HC and
CO at FTP-75 (XD 2.0 M/T) mode

| | HC | CO/10 |
|---|---|---|
| Comparative Example 1 | 24.3 | 33.0 |
| Example 1 | 23.2 | 30.3 |
| Example 2 | 22.6 | 29.7 |
| Example 3 | 22.1 | 27.0 |

Accordingly, it has been found that the palladium based catalyst containing the gallium had improved performance in the reduction of NOx as well as in the oxidation of HC and CO.

In the examples, the gallium is added to the conventional palladium based catalyst composition containing precious metals, so that the deNOx and the oxidation of HC and CO are improved, thereby realizing a catalyst composition having economic and technical effects superior to those of conventional catalyst compositions.

Although the examples of the invention have been described in detail, the examples are illustrative and the scope of the present invention is to be defined based on the accompanying claims.

What is claimed is:

1. A catalyst composition for purifying exhaust gases of an internal combustion engine, comprising a support impregnated with a platinum group metal component and a metal component including gallium.

2. The catalyst composition as set forth in claim 1, wherein the support is an activated compound selected from the group consisting of alumina, silica, silica-alumina, aluminosilicate, alumina-zirconia, alumina-chromia and alumina-ceria.

3. The catalyst composition as set forth in claim 1 or 2, wherein the gallium has a content ranging from 0.2 to 20 g/l.
